(19) United States
(12) Patent Application Publication
(10) Pub. No.: US 2014/0306898 A1
(43) Pub. Date: Oct. 16, 2014

(54) KEY SWIPE GESTURES FOR TOUCH SENSITIVE UI VIRTUAL KEYBOARD

(71) Applicant: BARNESANDNOBLE.COM LLC, New York, NY (US)

(72) Inventor: Gerald B. Cueto, San Jose, CA (US)

(73) Assignee: barnesandnoble.com llc, New York, NY (US)

(21) Appl. No.: 13/860,193

(22) Filed: Apr. 10, 2013

(51) Int. Cl. G06F 3/0488

(52) U.S. Cl. CPC G06F 3/04883; G06F 3/04886
USPC 345/173; 715/863; 715/773

(57) ABSTRACT

Techniques are disclosed for providing a virtual keyboard key swipe mode for touch sensitive computing devices. The keyboard key swipe mode allows for the selection and/or input of key options for a particular virtual keyboard key using swipe gestures started from that particular key. Key options may include, for example, uppercase letters, lowercase letters, numbers or characters. In one example case, an upward swipe gesture performed on a letter key causes an uppercase selection of that letter key and a downward swipe gesture performed on the letter key causes a lowercase selection of that letter key. In another example case, a rightward swipe gesture performed on an alphanumeric key may cause a first character selection and a leftward swipe gesture performed on the alphanumeric key may cause a second character selection. The keyboard key swipe mode may further include a change-all-keys user input that transitions all keys simultaneously.

### FIELD OF THE DISCLOSURE

This disclosure relates to computing devices, and more particularly, to input techniques for touch sensitive devices.

### BACKGROUND

Touch sensitive computing devices such as tablets, eReaders, mobile phones, smart phones, personal digital assistants (PDAs), and other such devices are commonly used for displaying consumable content. The content may be, for example, an eBook, an online article or website, images, documents, a movie or video, or a map, just to name a few types. Such devices are also useful for displaying a user interface that allows a user to interact with one or more applications or services running on the device. In some instances, the content is displayed and interacted with using a touch screen, while in other instances, the touch sensitive surface (such as a track pad) and display device (such as a non-touch sensitive monitor) may be separate. The user interface for these touch sensitive computing devices typically include a virtual keyboard (also referred to as a soft keyboard) for entering text and other characters. The virtual keyboard is typically displayed when a user is interacting with a text entry box or other various text input fields.

### BRIEF DESCRIPTION OF THE DRAWINGS

FIGS. 1a-b illustrate an example touch sensitive computing device having a virtual keyboard key swipe mode configured in accordance with an embodiment of the present invention.

FIGS. 1c-d illustrate example configuration screen shots of the user interface of the touch sensitive computing device shown in FIGS. 1a-b configured in accordance with an embodiment of the present invention.

FIG. 2a illustrates a block diagram of a touch sensitive computing device configured in accordance with an embodiment of the present invention.

FIG. 2b illustrates a block diagram of a communication system including the touch sensitive computing device of FIG. 2a configured in accordance with an embodiment of the present invention.

FIGS. 3a-f illustrate a keyboard key swipe mode on a touch sensitive computing device, in accordance with one or more embodiments of the present invention.

FIG. 4a-e illustrate a keyboard key swipe mode on a touch sensitive computing device, in accordance with one or more embodiments of the present invention.

FIG. 5 illustrates a method for providing a keyboard key swipe mode in a touch sensitive computing device, in accordance with an embodiment of the present invention.

### DETAILED DESCRIPTION

Techniques are disclosed for providing a virtual keyboard key swipe mode for touch sensitive computing devices. The keyboard key swipe mode allows for the selection and/or input of key options for a particular virtual keyboard key using swipe gestures started from that particular key. Key options may include uppercase letters, lowercase letters, numbers or characters. In one example case, an upward swipe gesture performed on a letter key causes an uppercase selection of said letter key and a downward swipe gesture performed on the letter key causes a lowercase selection of said letter key. In another example case, a rightward swipe gesture performed on an alphanumeric key causes a first character selection and a leftward swipe gesture performed on the alphanumeric key causes a second character selection. The keyboard key swipe mode may include a change-all-keys user input that transitions all keys simultaneously. Numerous other configurations and variations will be apparent in light of this disclosure.

General Overview

As previously explained, touch sensitive computing devices such as tablets, eReaders, and smart phones are commonly used for displaying user interfaces and consumable content. As was also explained, user interfaces for touch sensitive devices typically include a virtual keyboard for entering text and other characters into text boxes or other various text input fields. While most virtual keyboards provide methods for entering/inputting uppercase or lowercase letters and other symbols or characters, the methods typically require a user to tap one or more buttons before being able to access the desired letter case or character, thus leading to a diminished user experience. Moreover, the entire keyboard is changed or otherwise affected in response to that user input.

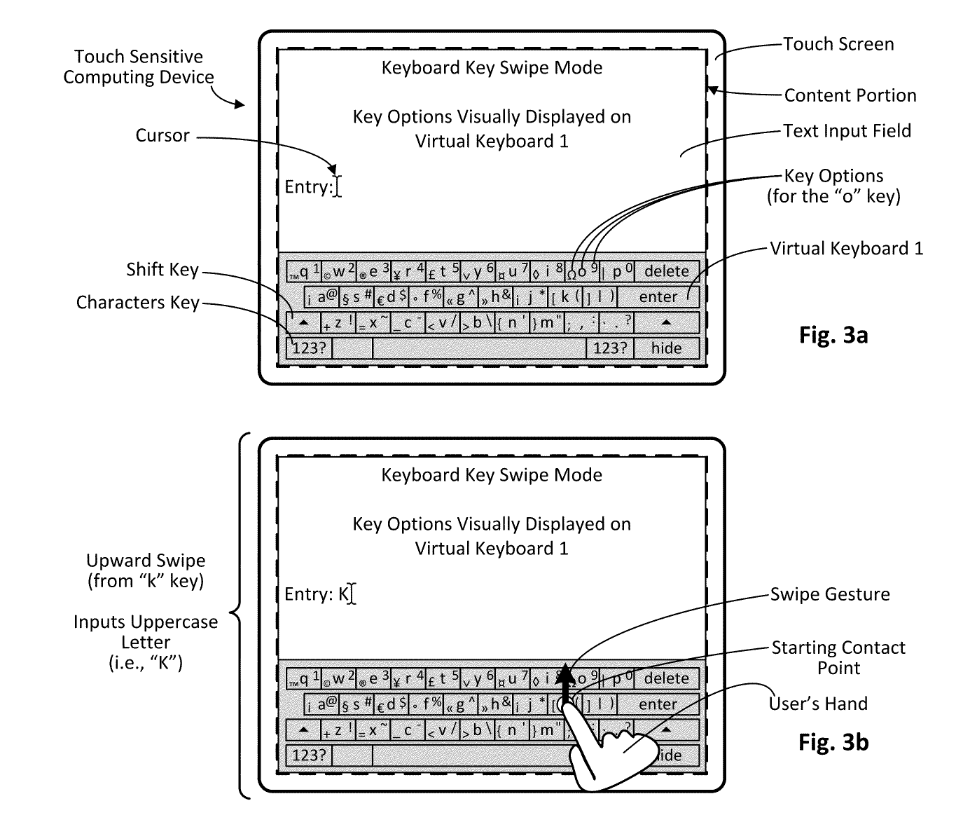

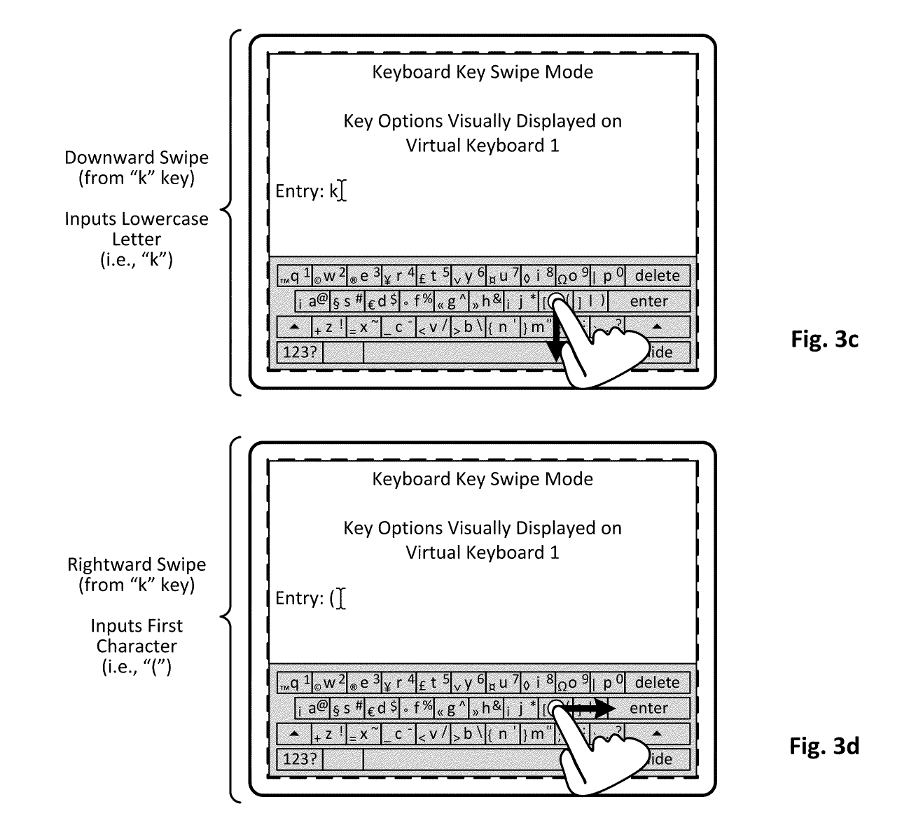

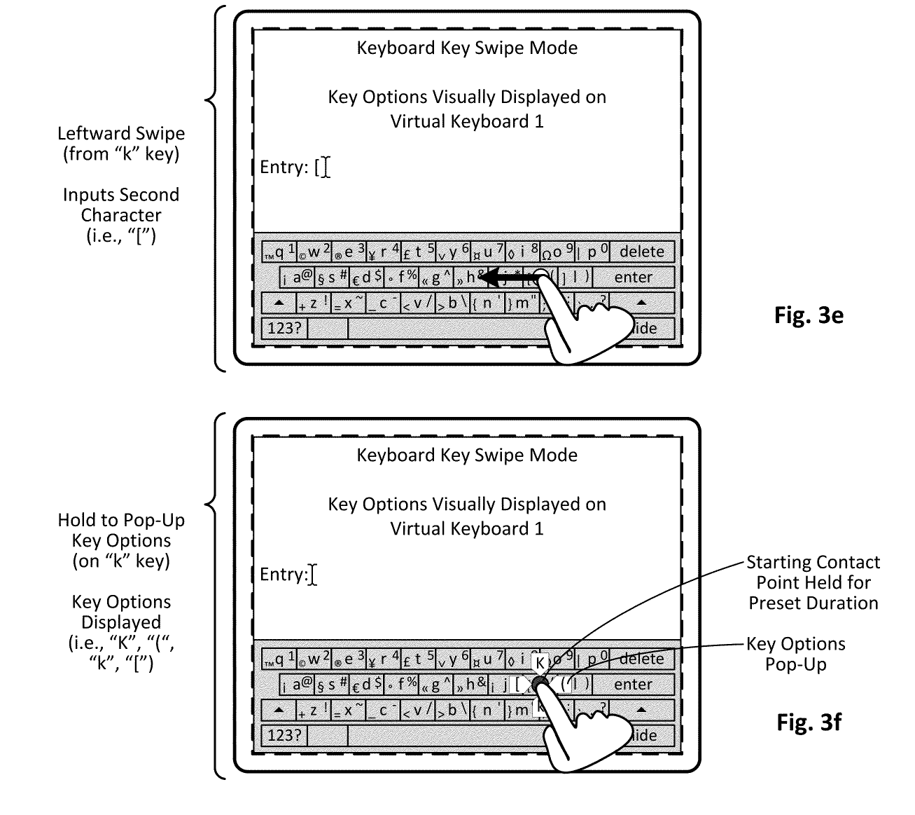

Thus, and in accordance with an embodiment of the present invention, techniques are disclosed for selecting and/or inputting text and other characters using swipe gestures on keys of a virtual keyboard of a touch sensitive computing device, referred to collectively herein as a keyboard key swipe mode. The keyboard key swipe mode described herein can be used with any virtual keyboard layout having any number of keys, but for ease of description, it will primarily be discussed in reference to a QWERTY virtual keyboard layout (such as the virtual keyboard shown in FIG. 3a). The keyboard key swipe mode may require one or more keys of the virtual keyboard to have two or more options per key, such that key-based swipe gestures can be used to select the desired option for a given key being swiped. For example, in a normal QWERTY virtual keyboard, all of the letter keys may have two options per key, i.e., a lowercase and uppercase option for each letter. In some instances, the keys may have more than two options, such as can be seen on the virtual keyboard shown in FIG. 3a. The key options assigned to each key may be predetermined (based on the virtual keyboard layout) or user-configurable (by configuring the virtual keyboard itself and/or by configuring the keyboard key swipe mode, as will be discussed in turn). The key options may include various inputs, such as inputs from the following categories: letters (of varying languages and cases), numbers, symbols, glyphs, navigation keys (e.g., arrows, page up/down, home, end, etc.), editing keys (e.g., enter, delete, tab, etc.), modifier keys (e.g., shift, control, alt, etc.), special characters, miscellaneous keyboard keys (e.g., escape, menu, language input, etc.), and/or a combination thereof. For ease of description, letters will be referred to herein as letters and all other inputs (including all of the previously described key option categories excluding letters) will be referred to herein as characters.

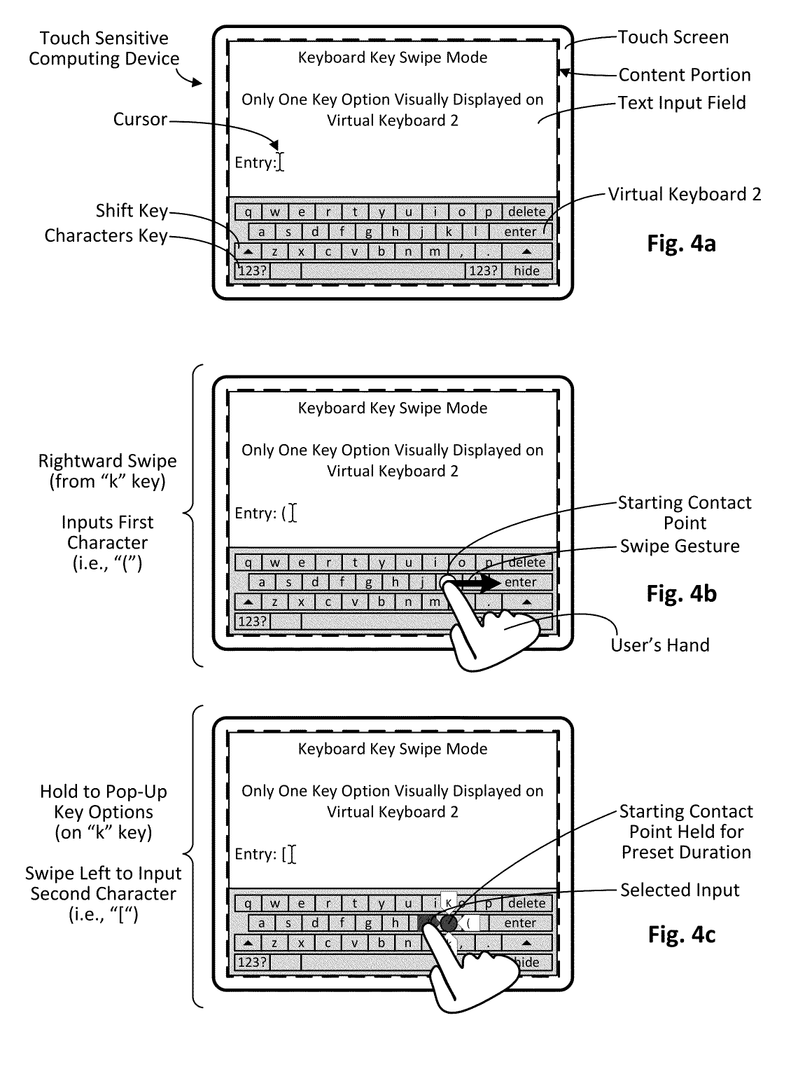

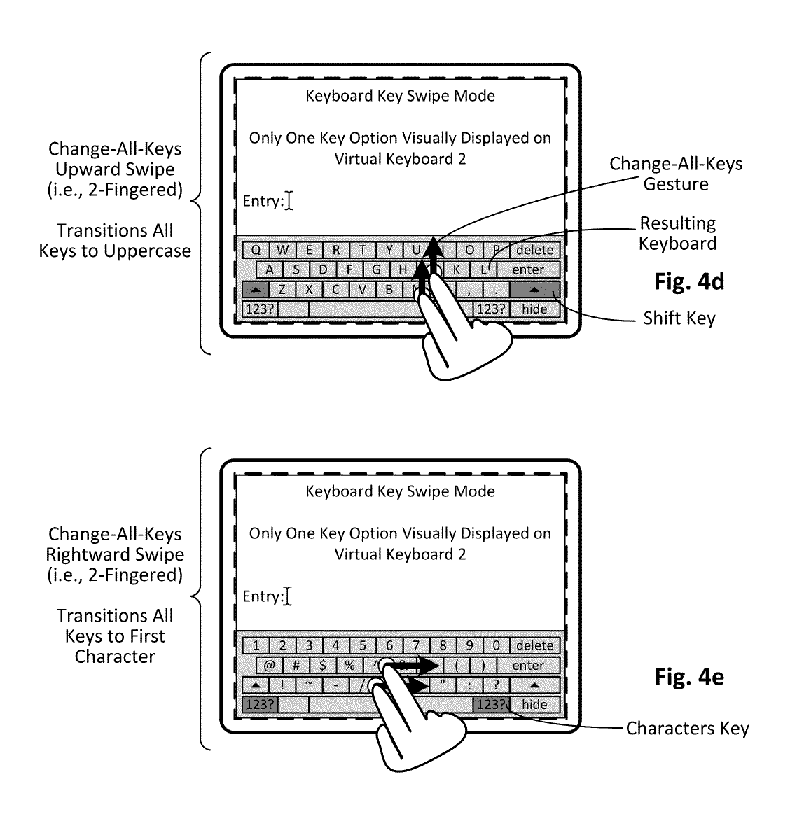

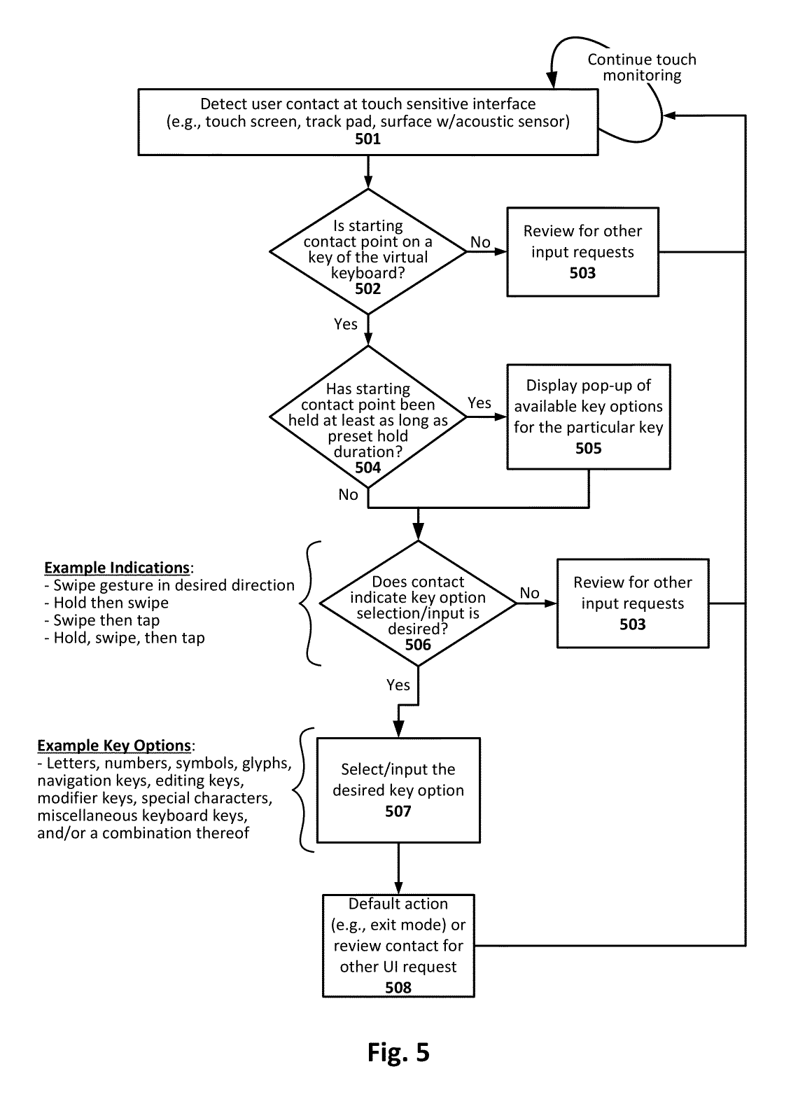

The keyboard key swipe mode is key specific and therefore may need swipe gestures to start (i.e., have a starting contact point) on the key that includes the desired key option, in some embodiments. For example, if an uppercase “H” is desired, then the user may have to start a swipe gesture on the “h” key to input the desired uppercase “H”, as will be apparent in light of this disclosure. As previously described, the key options per virtual keyboard key may vary or be user-configurable; therefore, the techniques described herein will be demonstrated for illustrative purposes using the example virtual keyboard layouts shown in FIG. 3a and FIG. 4a. In some cases, the keyboard key swipe mode may be configured such that a user can swipe in the direction of a desired key option to select/input that desired key option. In other cases, the keyboard key swipe mode may be configured such that a has to hold down the starting contact point for a preset duration (e.g., 0.5 to 1.5 seconds or other suitable duration) before swiping in the direction of a desired key option to select/input that desired key option. In some such cases, the key options may pop-up after holding the starting contact point for the preset duration (e.g., see FIG. 30. These example cases will be discussed in turn with reference to FIGS. 3a-f and 4a-c, as well as with reference to the methodologies demonstrated in FIG. 5. Some embodiments may include a change-all-keys feature, which will be discussed in turn with reference to FIGS. 4d-e.

As will also be apparent in light of this disclosure, key options for the keyboard key swipe mode may be: 1) visually indicated on the virtual keyboard prior to performing a swipe gesture; 2) displayed after the starting contact point of a swipe gesture is held for a preset duration; and/or 3) displayed external to the virtual keyboard (e.g., on a key options cheat-sheet or manual). Therefore, a varying degree of memorization of key options may be applicable when using the keyboard key swipe mode in some embodiments, but not all. For example, all of the key options for each key of the virtual keyboard shown in FIG. 3a are visually indicated on the virtual keyboard. In another example case, some of the key options may be shown (such as is the case of the virtual keyboard in FIG. 4a), while some key options may be hidden. In some such cases, the hidden key options may be displayed after the key is held for a preset duration, as previously described. For example, the key options may pop-up around the key on the virtual keyboard after the key is held for a preset duration, allowing a user to swipe to the desired option (e.g., see FIG. 4c).

In some embodiments, the functions performed when using a keyboard key swipe mode described herein may be configured at a global level (i.e., based on the UI settings of the electronic device) and/or at an application level (i.e., based on the specific application being displayed). To this end, the keyboard key swipe mode may be user-configurable in some cases, or hard-coded in other cases. Further, the keyboard key swipe mode as described herein may be included with a virtual keyboard or be a separate program/service configured to interface with a pre-existing virtual keyboard to incorporate the functionality of the keyboard key swipe mode as described herein (regardless of whether the virtual keyboard is UI based or application specific). For ease of reference, user input is sometimes referred to as contact or user contact; however, direct and/or proximate contact (e.g., hovering within a few centimeters of the touch sensitive surface) may be used to make the keyboard key swipe gestures described herein depending on the specific touch sensitive device being used. In other words, in some embodiments, a user may be able to use the keyboard key swipe mode without physically touching the touch sensitive device.

Device and Configuration Examples

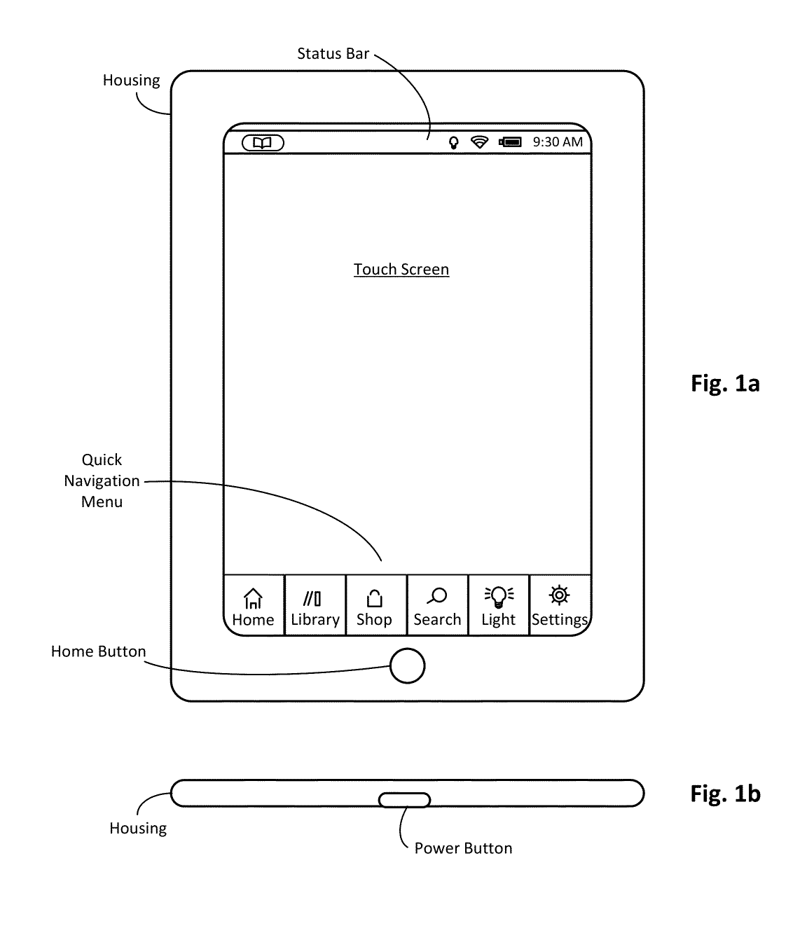

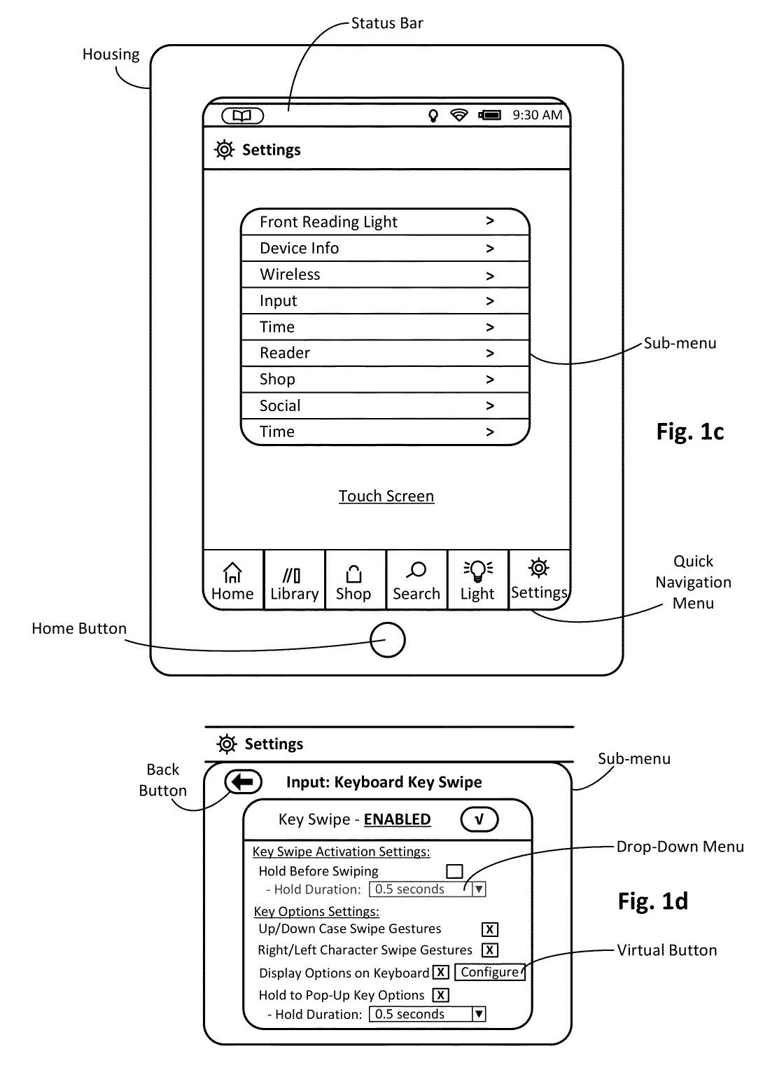

FIGS. 1a-b illustrate an example touch sensitive computing device having a virtual keyboard key swipe mode configured in accordance with an embodiment of the present invention. The device could be, for example, a tablet such as the NOOK® Tablet by Barnes & Noble. In a more general sense, the device may be any electronic device having a touch sensitive user interface and capability for displaying content to a user, such as a mobile phone or mobile computing device such as an eReader, a tablet or laptop, a desktop computing system, a television, a smart display screen, or any other device having a touch screen display or a non-touch display screen that can be used in conjunction with a touch sensitive surface. As will be appreciated in light of this disclosure, the claimed invention is not intended to be limited to any particular kind or type of electronic device.

As can be seen with this example configuration, the device comprises a housing that includes a number of hardware features such as a power button and a press-button (sometimes called a home button herein). A touch screen based user interface (UI) is also provided, which in this example embodiment includes a quick navigation menu having six main categories to choose from (Home, Library, Shop, Search, Light, and Settings) and a status bar that includes a number of icons (a night-light icon, a wireless network icon, and a book icon), a battery indicator, and a clock. Other embodiments may have fewer or additional such UI touch screen controls and features, or different UI touch screen controls and features altogether, depending on the target application of the device. Any such general UI controls and features can be implemented using any suitable conventional or custom technology, as will be appreciated.

The power button can be used to turn the device on and off, and may be used in conjunction with a touch-based UI control feature that allows the user to confirm a given power transition action request (e.g., such as a slide bar or tap point graphic to turn power off). In this example configuration, the home button is a physical press-button that can be used as follows: when the device is awake and in use, tapping the button will display the quick navigation menu, which is a toolbar that provides quick access to various features of the device. The home button may also be configured to hide a displayed virtual keyboard. Numerous other configurations and variations will be apparent in light of this disclosure, and the claimed invention is not intended to be limited to any particular set of hardware buttons or features, or device form factor.

As can be further seen, the status bar may also include a book icon (upper left corner). In some such cases, the user can access a sub-menu that provides access to a keyboard key swipe mode configuration sub-menu by tapping the book icon of the status bar. For example, upon receiving an indication that the user has touched the book icon, the device can then display the keyboard key swipe mode configuration sub-menu shown in FIG. 1d. In other cases, tapping the book icon may just provide information on the content being consumed. Another example way for the user to access a keyboard key swipe mode configuration sub-menu such as the one shown in FIG. 1d is to tap or otherwise touch the Settings option in the quick navigation menu, which causes the device to display the general sub-menu shown in FIG. 1c. From this general sub-menu the user can select any one of a number of options, including one designated Input in this specific example case. Selecting this sub-menu item (with, for example, an appropriately placed screen tap) may cause the keyboard key swipe mode configuration sub-menu of FIG. 1d to be displayed, in accordance with an embodiment. In other example embodiments, selecting the Input option may present the user with a number of additional sub-options, one of which may include a keyboard key swipe option as provided herein, which may then be selected by the user so as to cause the keyboard key swipe mode configuration sub-menu of FIG. 1d to be displayed. Any number of such menu schemes and nested hierarchies can be used, as will be appreciated in light of this disclosure.

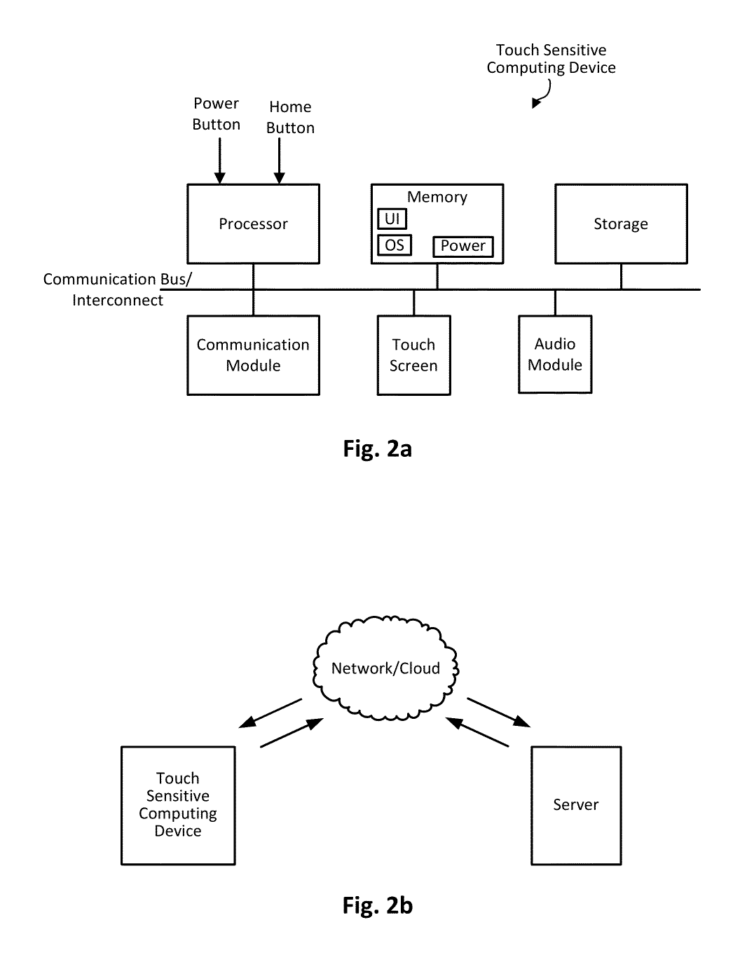

As will be appreciated, the various UI control features and sub-menus displayed to the user are implemented as UI touch screen controls in this example embodiment. Such UI touch screen controls can be programmed or otherwise configured using any number of conventional or custom technologies. In general, the touch screen translates the user touch (e.g., direct or proximate contact) in a given location into an electrical signal which is then received and processed by the underlying operating system (OS) and circuitry (processor, etc.). Additional example details of the underlying OS and circuitry in accordance with some embodiments will be discussed in turn with reference to FIG. 2a. In some cases, the keyboard key swipe mode may be automatically configured by the specific UI or application being used. In other cases, the keyboard key swipe mode may be hard-coded directly into the virtual keyboard module. In these cases, the keyboard key swipe mode need not be user-configurable (e.g., if the keyboard key swipe mode is hard coded or is otherwise automatically configured).

As previously explained, and with further reference to FIGS. 1c and 1d, once the Settings sub-menu is displayed (FIG. 1c), the user can then select the Input option. In response to such a selection, the keyboard key swipe mode configuration sub-menu shown in FIG. 1d can be provided to the user. In this example case, the keyboard key swipe mode configuration sub-menu includes a UI check box that when checked or otherwise selected by the user, effectively enables the keyboard key swipe mode (shown in the enabled state); unchecking the box disables the mode. Other embodiments may have the keyboard key swipe gesture mode always enabled, or enabled by a switch or button, for example. In some instances, the keyboard key swipe mode may be automatically enabled in response to an action, such as when a virtual keyboard is displayed and/or a text input field is active (i.e., interaction with the virtual keyboard will enter text in the input field). As previously described, the user may be able to configure some of the features with respect to the keyboard key swipe mode, so as to effectively give the user a say in when the keyboard key swipe mode is available, if so desired.

In the example case shown in FIG. 1d, once the keyboard key swipe mode is enabled, the user can choose the Key Swipe Activation Settings, which in this case allows a user to enable/disable Hold Before Swiping (shown in the disabled state). Since this setting is disabled, the user does not need to hold the starting contact point of swipe gestures before activating the keyboard key swipe mode. In other words, the user can use swipe gestures to select key options without holding the starting contact point of the swipe gesture. When the Hold Before Swiping setting is enabled, the user can then select a Hold Duration to preset the minimum duration of the hold. The Hold Duration is shown preset at 0.5 seconds; however, the Hold Duration may also be set at 0.25, 0.75, 1.0, 1.25, 1.5, 1.75, or 2.0 seconds (or some other suitable duration) by using the drop-down menu shown, for example. Such configurability can be used to provide a degree of uniqueness so as to distinguish one mode from another mode. The keyboard key swipe mode may also be configured with a default preset hold duration when the starting contact point has to be held before swiping (regardless of whether the hold requirement is hard-coded or user-configurable).

The example settings screen shot shown in FIG. 1d also includes various Key Options Settings. As previously described, key options as used herein are the selectable letters or other characters per keyboard key available by using swipe gestures as disclosed herein. The Key Options Settings shown in this example case apply to a keyboard key swipe mode embodiment that allows Up/Down Case Swipe Gestures and Right/Left Character Swipe Gestures. Up/Down Case Swipe Gestures (shown in the enabled state) allow a user to swipe up on a letter key to input that letter in uppercase and swipe down on a letter to input that letter key in lowercase. Right/Left Character Swipe Gestures (shown in the enabled state) allow a user to swipe right on a keyboard key to input a corresponding first character and swipe left on a keyboard key to input a corresponding second character. As previously described, characters as used herein may include numbers, symbols, glyphs, navigation keys, editing keys, modifier keys, special characters, miscellaneous keyboard keys, and/or a combination thereof. These swipe gesture techniques will be discussed in turn (such as those described with reference to FIGS. 3b-e). Up/down and right/left swipe gestures are being used herein for illustrative purposes only and are not intended to limit the claimed invention to only four possible key options/swipe gesture directions. Any number of key options and related swipe gesture directions may be used including diagonal gestures and combinational gestures, such as a swipe gesture then a tap. As was previously described, the key options (and related swipe gesture direction) assigned to each key may be hard-coded, user-configurable, or some combination thereof.

The next Key Options Setting for the example case shown in FIG. 1d relates to the display of the key options on the virtual keyboard using a keyboard key swipe mode as described herein. The keyboard key swipe mode in this example case allows a user to configure whether the key options are displayed on the keyboard (i.e., Display Options on Keyboard). In this case, the Display Options on Keyboard setting option is enabled, resulting in a virtual keyboard that displays all key options, such as virtual keyboard 1 shown in FIG. 3a. Disabling the Display Options on Keyboard setting option may cause the virtual keyboard to hide some or all of the key options, such as in the case of virtual keyboard 2 shown in FIG. 4a. Regardless of whether the key options are displayed, a user can still use the keyboard key swipe mode as described herein to select the available key options (using the appropriate swipe gesture). However, when the key options are not displayed, the user may have to hold a key for a preset duration to see the respective key options pop-up or it may require the user to memorize the key options per keyboard key. The display options may be further configured using a Configure virtual button. For example, further configuration may include assigning key options to particular keys and/or designating how to display key options within each key.

The other Key Options Setting for the example case shown in FIG. 1d relates to whether a user can hold contact on a particular key to pop-up the respective key options for that key (i.e., Hold to Pop-Up Key Options). The Hold to Pop-Up Key Options setting option is shown in an enabled state, such that if a user holds a key for a preset Hold Duration, then the key options will pop-up for that particular key. The key options may be displayed in numerous different ways, such as is shown in FIG. 3f, for example. In addition, the Hold Duration is shown preset at 0.5 seconds; however, the Hold Duration may also be set at 0.25, 0.75, 1.0, 1.25, 1.5, 1.75, or 2.0 seconds (or some other suitable duration) by using the drop-down menu shown, for example. Numerous such configurations will be apparent in light of this disclosure.

In other example cases, the user may specify a number of applications in which the keyboard key swipe mode can be invoked. Such a configuration feature may be helpful, for instance, in a tablet or smartphone or other multifunction computing device that can execute different applications (as opposed to a device that is more or less dedicated to a particular application). In one example case, for instance, the available applications could be provided along with a corresponding check box. Example diverse applications include an eBook application, a document editing application, a text or chat messaging application, a browser application, a file manager application, a word processor application, a document viewer application, or any application including text based search, to name a few. In other embodiments, the keyboard key swipe mode can be invoked whenever the virtual keyboard application is running or is displayed on the screen, regardless of the application being used. Any number of applications or device functions may benefit from a keyboard key swipe mode as provided herein, whether user-configurable or not, and the claimed invention is not intended to be limited to any particular application or set of applications.

As can be further seen, a back button arrow UI control feature may be provisioned on the touch screen for any of the menus provided, so that the user can go back to the previous menu, if so desired. Note that configuration settings provided by the user can be saved automatically (e.g., user input is saved as selections are made or otherwise provided). Alternatively, a save button or other such UI feature can be provisioned, which the user can engage as desired. Again, while FIGS. 1c and 1d show user configurability, other embodiments may not allow for any such configuration, wherein the various features provided are hard-coded or otherwise provisioned by default. The degree of hard-coding versus user-configurability can vary from one embodiment to the next, and the claimed invention is not intended to be limited to any particular configuration scheme of any kind.

Architecture

FIG. 2a illustrates a block diagram of a touch sensitive computing device configured in accordance with an embodiment of the present invention. As can be seen, this example device includes a processor, memory (e.g., RAM and/or ROM for processor workspace and storage), additional storage/memory (e.g., for content), a communications module, a touch screen, and an audio module. A communications bus and interconnect is also provided to allow inter-device communication. Other typical componentry and functionality not reflected in the block diagram will be apparent (e.g., battery, co-processor, etc). Further note that although a touch screen display is provided, other embodiments may include a non-touch screen and a touch sensitive surface such as a track pad, or a touch sensitive housing configured with one or more acoustic sensors, etc. In any such cases, the touch sensitive surface is generally capable of translating a user's physical contact (whether direct or proximate) with the surface (e.g., touching the surface with a finger or an implement, such as a stylus) into an electronic signal that can be manipulated or otherwise used to trigger a specific user interface action, such as those provided herein. The principles provided herein equally apply to any such touch sensitive devices. For ease of description, examples are provided with touch screen technology.

The touch sensitive surface (touch sensitive display in this example) can be any device that is configured with user input detecting technologies, whether capacitive, resistive, acoustic, active or passive stylus, and/or other input detecting technology. The screen display can be layered above input sensors, such as a capacitive sensor grid for passive touch-based input (e.g. with a finger or passive stylus in the case of a so-called in-plane switching (IPS) panel), or an electro-magnetic resonance (EMR) sensor grid (e.g., for sensing a resonant circuit of the stylus). In some embodiments, the touch screen display can be configured with a purely capacitive sensor, while in other embodiments the touch screen display may be configured to provide a hybrid mode that allows for both capacitive input and active stylus input. In still other embodiments, the touch screen display may be configured with only an active stylus sensor. In any such embodiments, a touch screen controller may be configured to selectively scan the touch screen display and/or selectively report contacts detected directly on or otherwise sufficiently proximate to (e.g., within a few centimeters) the touch screen display. Numerous touch screen display configurations can be implemented using any number of known or proprietary screen based input detecting technology.

Continuing with the example embodiment shown in FIG. 2a, the memory includes a number of modules stored therein that can be accessed and executed by the processor (and/or a co-processor). The modules include an operating system (OS), a user interface (UI), and a power conservation routine (Power). The modules can be implemented, for example, in any suitable programming language (e.g., C, C++, objective C, JavaScript, custom or proprietary instruction sets, etc.), and encoded on a machine readable medium, that when executed by the processor (and/or co-processors), carries out the functionality of the device including a virtual keyboard key swipe mode as variously described herein. The computer readable medium may be, for example, a hard drive, compact disk, memory stick, server, or any suitable non-transitory computer/computing device memory that includes executable instructions, or a plurality or combination of such memories. Other embodiments can be implemented, for instance, with gate-level logic or an application-specific integrated circuit (ASIC) or chip set or other such purpose built logic, or a microcontroller having input/output capability (e.g., inputs for receiving user inputs and outputs for directing other components) and a number of embedded routines for carrying out the device functionality. In short, the functional modules can be implemented in hardware, software, firmware, or a combination thereof.

The processor can be any suitable processor (e.g., 800 MHz Texas Instruments® OMAP3621 applications processor), and may include one or more co-processors or controllers to assist in device control. In this example case, the processor receives input from the user, including input from or otherwise derived from the power button, home button, and touch sensitive surface. The processor can also have a direct connection to a battery so that it can perform base level tasks even during sleep or low power modes. The memory (e.g., for processor workspace and executable file storage) can be any suitable type of memory and size (e.g., 256 or 512 Mbytes SDRAM), and in other embodiments may be implemented with non-volatile memory or a combination of non-volatile and volatile memory technologies. The storage (e.g., for storing consumable content and user files) can also be implemented with any suitable memory and size (e.g., 2 GBytes of flash memory).

The display can be implemented, for example, with a 6-inch E-ink Pearl 800×600 pixel screen with Neonode® zForce® touch screen, or any other suitable display and touch screen interface technology. The communications module can be, for instance, any suitable 802.11b/g/n WLAN chip or chip set, which allows for connection to a local network so that content can be downloaded to the device from a remote location (e.g., content provider, etc, depending on the application of the display device). In some specific example embodiments, the device housing that contains all the various componentry measures about 6.5″ high by about 5″ wide by about 0.5″ thick, and weighs about 6.9 ounces. Any number of suitable form factors can be used, depending on the target application (e.g., laptop, desktop, mobile phone, etc.). The device may be smaller, for example, for smart phone and tablet applications and larger for smart computer monitor and laptop applications.

The operating system (OS) module can be implemented with any suitable OS, but in some example embodiments is implemented with Google Android OS or Linux OS or Microsoft OS or Apple OS. As will be appreciated in light of this disclosure, the techniques provided herein can be implemented on any such platforms, or other platforms including a virtual keyboard. The power management (Power) module can be configured as typically done, such as to automatically transition the device to a low power consumption or sleep mode after a period of non-use. A wake-up from that sleep mode can be achieved, for example, by a physical button press and/or a touch screen swipe or other action. The user interface (UI) module and example use-cases can be, for example, based on touch screen technology and the various example screen shots shown in FIGS. 1a, 1c-d, 3a-f, and 4a-c, in conjunction with the keyboard key swipe mode methodologies demonstrated in FIG. 5, which will be discussed in turn. The audio module can be configured, for example, to speak or otherwise aurally present a selected eBook or other textual content, if preferred by the user. In some example cases, if additional space is desired, for example, to store digital books or other content and media, storage can be expanded via a microSD card or other suitable memory expansion technology (e.g., 32 GBytes, or higher).

Client-Server System

FIG. 2b illustrates a block diagram of a communication system including the touch sensitive computing device of FIG. 2a, configured in accordance with an embodiment of the present invention. As can be seen, the system generally includes a touch sensitive computing device that is capable of communicating with a server via a network/cloud. In this example embodiment, the touch sensitive computing device may be, for example, an eReader, a mobile phone, a smart phone, a laptop, a tablet, a desktop computer, or any other touch sensitive computing device. The network/cloud may be a public and/or private network, such as a private local area network operatively coupled to a wide area network such as the Internet. In this example embodiment, the server may be programmed or otherwise configured to receive content requests from a user via the touch sensitive device and to respond to those requests by providing the user with requested or otherwise recommended content. In some such embodiments, the server may be configured to remotely provision a keyboard key swipe mode as provided herein to the touch sensitive device (e.g., via JavaScript or other browser based technology). In other embodiments, portions of the methodology may be executed on the server and other portions of the methodology may be executed on the device. Numerous server-side/client-side execution schemes can be implemented to facilitate a keyboard key swipe mode in accordance with one or more embodiments, as will be apparent in light of this disclosure.

Key Swipe Gesture Examples

FIGS. 3a-f illustrate a keyboard key swipe mode on a touch sensitive computing device, in accordance with an embodiment of the present invention. As shown in FIG. 3a, the device includes a frame that houses a touch sensitive surface, which in this example, is a touch screen display. In some embodiments, the touch sensitive surface may be separate from the display, such as is the case with a track pad. In this example embodiment, the touch screen display contains a content portion (within the dashed line area). As previously described, any touch sensitive surface for receiving user input may be used for keyboard key swipe gestures as described herein. The keyboard key swipe gestures may be made by a user's hand(s) and/or by one or more implements (such as a stylus or pen), for example. The keyboard key swipe gestures and features shown in FIGS. 3b-f are provided for illustrative purposes only and are not exhaustive of all possible keyboard key swipe mode configurations and features, and are not intended to limit the claimed invention. Further, the swipe gestures shown in FIGS. 3b-f illustrate key option input; however, the swipe gestures may also be used for key option selection, as will be apparent in light of this disclosure.

For ease of description, the keyboard key swipe mode will be discussed with reference to four potential assignable key options per particular key, and therefore four different possible swipe gestures (e.g., up, down, right, and left swipe gestures), as will be apparent in light of this disclosure. However, the keyboard key swipe mode may be configured to recognize any number of key options and corresponding swipe gestures. For example, the keyboard key swipe mode may be configured to allow eight key options per virtual keyboard key which can then be selected using one of eight different swipe gestures, such as up, down, right, left, up-right diagonal, down-right diagonal, down-left diagonal, and up-left diagonal swipe gestures. In some embodiments, the keyboard key swipe mode may be configured to use a swipe plus tap gesture, wherein the swipe selects the key option and the tap inputs the key option, as will be apparent in light of this disclosure. In any case, recall that the key options and/or swipe gestures for key option selection may be configured by the user to a given extent in some embodiments. Other embodiments, however, may be hard-coded or otherwise have preselected key options and/or corresponding swipe gestures for each particular key.

FIG. 3a shows a text input field in the upper part of the content portion and a virtual keyboard in the lower part, as may be displayed, for example, in a word processing or note application. The text input field may be any field or box that allows the entry of text and/or other characters via a virtual keyboard, for example. A cursor is typically displayed in the text input field when the field is active (such as is the case in this example screen shot) to indicate the position in the field that will respond to input from the virtual keyboard (or other input mechanisms). In some instances, the virtual keyboard will always be displayed, while in other instances, the virtual keyboard will appear or only be displayed when a text input field becomes active, such as when a user selects the text input field (e.g., with an appropriately positioned tap).

Virtual keyboards capable of using a keyboard key swipe mode as disclosed herein may have any layout or configuration, such as the QWERTY keyboard layout as shown in FIG. 3a, a numerical keyboard, a foreign language keyboard, or any other layout consisting of multiple buttons or keys. In some instances, the virtual keyboard may have multiple selectable layouts. Although the virtual keyboard is shown in this example embodiment as a part of the display, in other embodiments, the virtual keyboard may have a different format, such as an optically projected keyboard layout or other optical detection system for keyboard input, for example. A user can interact with the virtual keyboard by making contact with a particular key to select/input that particular key. For example, an appropriately positioned tap (or hover input) on an alpha-numeric key, such as the “h” key, inputs that alpha-numeric (i.e., the letter “h”) at the cursor location. Further, selection of non-alphanumeric keys may cause various functions. For example, looking at virtual keyboard 1 in FIG. 3a, the shift key is a modifier key that can be used for various functions, such as to change the case of letters (uppercase vs. lowercase) when selected or to cause highlighting in combination with cursor movement when held. Another key example shown is the characters key, which can be used to change the displayed layout of the virtual keyboard whereby the primary key inputs are characters (as opposed to having primary input of letters in the layout shown).

The device in FIG. 3a includes a virtual keyboard (i.e., virtual keyboard 1) that visually displays all of the key options. In this example embodiment, multiple key options have been assigned to the alphanumeric keys (i.e., the letter and punctuation keys in this case), as can be seen. For example, the “o” key has four key options—an upper case “O”, a lower case “o”, the number “9”, and an omega symbol “Ω”. As will be apparent in light of this disclosure, the swipe gestures assigned for this particular embodiment include: up swipe gestures for upper case letters, down swipe gestures for lower case letters, right swipe gestures for a first character, and left swipe gestures for a second character. Continuing with the “o” key example, an up swipe inputs the upper case letter “O”, a down swipe inputs the lower case letter “o”, a right swipe inputs the first character “9”, and a left swipe inputs the second character “Ω”. As a side note, the two punctuation mark keys in this example embodiment (the comma “,” key and the period “.” key) only have three key options assigned to each key. Therefore, the keyboard key swipe mode may be configured to interpret both up and down swipes on those keys as an input for the respective punctuation mark, or only left and right swipes may be recognized for those two keys, for example. The swipe gestures and corresponding input for this example embodiment are further illustrated in FIGS. 3b-3e, which will be discussed in turn.

FIG. 3b illustrates an upward swipe gesture and resulting input using the keyboard key swipe mode performed on the virtual keyboard shown in FIG. 3a. As previously described, in this keyboard key swipe mode example embodiment, upward swipe gestures input upper case letters (when performed on letter keys). As shown in FIG. 3b, the swipe gesture has a starting contact point on a particular letter key, in this case, the “k” key. The starting contact point determines the particular key being used to provide the key options for the keyboard key swipe mode. As can be seen, an upward swipe gesture is performed from the “k” key by a user's hand (more specifically, the user's index finger) to input an uppercase “K” at the cursor position. In some cases, the keyboard key swipe mode may be configured to input the desired key option (in this case, the uppercase “K”) after the upward swipe gesture is made. In other cases, the keyboard key swipe mode may be configured to input the desired key option after the swipe gesture contact is released. In other cases, the keyboard key swipe mode may be configured to select the desired key option of a particular key using a swipe gesture, allowing for a subsequently placed tap on the particular key to input the selected key option. In such cases, the keyboard key swipe mode may be configured to change the selected key option for tap input in various ways, such as the selected key option may only last for one input and then revert back to the default primary key option for tap input, or the selected key option may maintain the tap input until a different key option is selected (using a swipe gesture). Also, the particular key display may change to display the selected key option until an action (e.g., until a different key option is selected) reverts the particular key back to its original state.

FIG. 3c illustrates a downward swipe gesture and resulting input using the keyboard key swipe mode performed on the virtual keyboard shown in FIG. 3a. As shown in FIG. 3c, a downward swipe from the “k” key results in the input of a lowercase “k”. FIG. 3d illustrates a rightward swipe gesture and resulting input using the keyboard key swipe mode performed on the virtual keyboard shown in FIG. 3a. As shown in FIG. 3d, a rightward swipe from the “k” key results in the input of a left parenthetical “(”, which is the character assigned to the first character key option for the “k” key. FIG. 3e illustrates a rightward swipe gesture and resulting input using the keyboard key swipe mode performed on the virtual keyboard shown in FIG. 3a. As shown in FIG. 3e, a leftward swipe from the “k” key results in the input of a left bracket “[”, which is the character assigned to the second character key option for the “k” key.

FIG. 3f illustrates a hold to pop-up key options feature of the keyboard key swipe mode. As shown in FIG. 3f, the starting contact point was held for at least as long as a preset duration to cause a key options pop-up to be displayed. As previously described, the preset hold may be hard-coded or user-configurable (e.g., see FIG. 1d). The starting contact point is shown in grey to indicate that it was held for at least as long as the preset hold duration. The pop-up display shows all of the key options for the particular keyboard key on which the starting contact point was held. In this example case, the “k” was held to pop-up the assigned key options (and respective swipe gesture directions): “K” (up swipe), “(” (right swipe), “k” (down swipe), and “[” (left swipe). Selection of one of the key options after holding for the key options pop-up display will be discussed in turn with reference to FIG. 4c.

FIG. 4a-e illustrate a keyboard key swipe mode on a touch sensitive computing device, in accordance with an embodiment of the present invention. As shown in FIG. 4a, the device is the same as the device shown in FIG. 3a and described herein. However, the device in FIG. 4a includes a virtual keyboard (i.e., virtual keyboard 2) that only displays one key option for the keyboard key swipe mode. In this example embodiment, the key options of virtual keyboard 2 (in FIG. 4a) are the same as those shown on virtual keyboard 1 (in FIG. 3a), allowing a user to perform swipe gestures to input key options in the same manner as shown in FIGS. 3b-e. For example, as can be seen in FIG. 4b, a rightward swipe from the “k” key inputs the first character key option assigned to that key—a left parenthetical “(” character—which is the same gesture and input shown in FIG. 3d. In addition, an upward swipe on the “k” key of virtual keyboard 2 inputs an uppercase “K”, a downward swipe inputs a lower case “k”, and a leftward swipe inputs the second character assigned to the “k” key—a left bracket “[”. Therefore, where some key options are hidden, increased memorization may be applicable to use the keyboard key swipe mode, but the keyboard layout may also be less cluttered.

FIG. 4c illustrates a hold to pop-up key options feature of the keyboard key swipe mode and a swipe gesture selection of one of the key options, in accordance with an embodiment of the present invention. As shown in FIG. 4c, the starting contact point was held for at least as long as a preset duration to cause a key options pop-up to be displayed. This causes a pop-up display of the same key options described with reference to FIG. 3f. As can be seen in FIG. 4c, after the key options pop-up, the user made a leftward swipe gesture to input the second character (i.e., “[”), which is shown entered in the text input field. In this example embodiment, the selected input is highlighted when a user swipes over it (while maintaining contact after the hold) to indicate that it is the selected key option input. If the hold to pop-up is released before swiping, then no input will be entered (such as was the case in FIG. 3f). In some cases, the user may have to release contact on the selected key option input to select it. In some other cases, the user may have to swipe in the desired key option direction and release anywhere along that swipe gesture to input the corresponding key option selection. In yet some other cases, the input may be entered after the user swipes in the direction of the desired key option input (i.e., before releasing contact).

FIG. 4d-e illustrate a change-all-keys feature of the keyboard key swipe mode, in accordance with an embodiment of the present invention. The change-all-keys feature is activated using a user input different than the swipe gestures described herein to cause selection and/or input of key options for a particular key. The change-all-keys user input may be a button selection (e.g., selection of the shift key or characters key) or a swipe gesture different from the gestures used to select/input key options for particular keys. For example, if the swipe gestures used to select/input key options for particular keys are performed using one starting contact point (e.g., one finger), then the change-all-keys user input may use two starting contact points (e.g., two fingers). Therefore, the user input for swipe gestures that cause key option selection/input for a particular key and the change-all-keys user input may be hard-coded, user-configurable, or some combination thereof.

Further, the swipe gestures used to select/input a key option from a particular key affect only that particular key and have no effect on the other keys of the virtual keyboard. However, the change-all-keys feature transitions all keys simultaneously to a corresponding key option determined by the change-all-keys user input. For example, as shown in FIG. 4d, a change-all-keys swipe gesture (i.e., a two-fingered upward swipe) was used to transition all of the keys to the desired key option (i.e., all keys become uppercase). As previously described, upward swipe gestures in this example embodiment correspond to the key option of uppercase letters, and since the change-all-keys user input is being used (i.e., a swipe gesture having two starting contact points), all keys were transitioned to their uppercase key options. This is shown in the resulting keyboard of FIG. 4d (compare to the original state of virtual keyboard 2 shown in FIG. 4a). The change-all-keys swipe gesture is not key specific and can therefore be performed anywhere on the virtual keyboard to transition all of the keys to the corresponding key option. The shift key is highlighted in this example case to visually indicate that the entire keyboard has been transitioned to uppercase key options.

FIG. 4e illustrates another change-all-keys user input (i.e., a two-fingered rightward swipe gesture), which was used to transition all of the keys to the desired key option (i.e., all keys become first character key option). As previously described, rightward swipe gestures in this example embodiment correspond to the key option of the first character, and since the change-all-keys user input is being used (i.e., a swipe gesture having two starting contact points), all keys were transitioned to their first character key options. This is shown in the resulting keyboard of FIG. 4e (compare to the original state of virtual keyboard 2 shown in FIG. 4a). The characters key is highlighted in this example case to visually indicate that the entire keyboard has been transitioned to first character key options. Numerous different virtual keyboard key swipe gestures and configurations will be apparent in light of this disclosure.

Methodology

FIG. 5 illustrates a method for providing a keyboard key swipe mode in a touch sensitive computing device, in accordance with an embodiment of the present invention. This example methodology may be implemented, for instance, by the UI module of the touch sensitive device shown in FIG. 2a, or the touch sensitive device shown in FIG. 2b (e.g., with the UI provisioned to the client by the server). To this end, the UI can be implemented in software, hardware, firmware, or any combination thereof, as will be appreciated in light of this disclosure.

As can be seen, the method generally includes sensing a user's input (e.g., direct contact or hover input) by a touch sensitive surface. In general, any touch sensitive device may be used to detect contact with it by one or more fingers and/or styluses or other suitable implements. Since direct or proximate contact is location specific relative to the displayed content, the UI can detect whether the contact starts on a key of a displayed virtual keyboard. As soon as the user begins to drag or otherwise move the contact point(s) (i.e., starting contact point(s)), the UI code (and/or hardware) can assume a swipe gesture has been engaged and track the path of each contact point with respect to any fixed point within the touch surface until the user stops engaging the touch sensitive surface. The release point can also be captured by the UI as it may be used to execute or stop executing the action started when the user pressed on the touch sensitive surface (e.g., in the case where a user holds the gesture and changes to a different key option releasing the gesture). These main detections can be used in various ways to implement UI functionality, including a keyboard key swipe mode as variously described herein, as will be appreciated in light of this disclosure.

In this example case, the method includes detecting 501 user contact at the touch sensitive interface. In general, the touch monitoring is effectively continuous. The method continues with determining 502 if the starting contact point is on a key of the virtual keyboard. This may include an initial step of determining whether a virtual keyboard is being displayed. If a virtual keyboard is not displayed or user contact does not start on a key of the virtual keyboard, then the method may continue with reviewing 503 the contact for some other UI requests (e.g., select a file, send an email, etc.). If a virtual keyboard is displayed and the starting contact point is on a key of the virtual keyboard, the method continues by determining 504 if the starting contact point has been held at least as long as a preset hold duration. If it has, then the method displays 505 a pop-up of the available key options for the particular key (e.g., see FIG. 3f). This may include an initial step of determining whether the pop-up feature is available and/or enabled (e.g., see Hold to Pop-Up Key Options setting option in FIG. 1d). In addition, the preset hold duration may be hard-coded or user-configurable, and hold durations may include 0.25, 0.5, 0.75, 1.0, 1.25, 1.5, 1.75, or 2.0 seconds, for example.

If the starting contact point has not been held for at least as long as the preset hold duration (or, e.g., if the Hold to Pop-Up Key Options feature is unavailable), the method continues with determining 506 if the contact indicates a key option selection and/or input is desired. The method also continues with this step even if a pop-up of the available key options for the particular key are displayed 505. Determining 506 if the contact indicates that a key option selection/input is desired may include determining if a swipe gesture is made from the particular key in the direction of a desired key option. This may include an initial step of determining whether there is an available key option for the swipe gesture performed. In other words, where a key only has one key option (i.e., the key displayed), then a swipe gesture starting on that key may be interpreted in the same manner as a tap on that key or as no input (e.g., if the swipe gesture ends outside of the bounds of that key).

Continuing with step 506, in some keyboard key swipe mode configurations, the starting contact point may have to be held for a preset duration prior to performing the swipe gesture to select/input the desired key option. In such a configuration, the method may determine if the starting contact point has been held at least as long as a preset hold duration to activate a key swipe, similar to step 504. In some cases, where the starting contact point has to be held to activate a key swipe gesture, the preset hold duration may be the same or different than a preset hold duration used to display a pop-up of available key options (if such a feature is included). If a swipe (or hold then swipe) gesture is being used to select a desired key option for a particular key (e.g., by swiping in the direction of the desired key option), then a subsequent tap may be used to input that desired key option. In this manner, the display for that particular key may change to the selected key option, as previously described. Recall that the mode may be configured by the user to a given extent, in some embodiments. Other embodiments, however, may be hard-coded or otherwise configured to carry out certain specific actions without allowing for user configuration, as will be further appreciated in light of this disclosure.

If the contact does not indicate that a key option input is desired, then the method may continue with reviewing 503 the contact for some other UI or input requests. For example, since the contact was made on the virtual keyboard, other input requests may include a tap of one or more virtual keyboard keys (as opposed to press and hold or swipe gestures on the keys). Where the available key options for the particular key have been displayed (i.e., where step 505 is carried out), but the contact does not indicate that a key option input is desired, the pop-up display can be hidden after the contact is released (i.e., after the particular key is no longer held). However, if the contact does indicate that a key option input is desired, then the method continues with a selection and/or input 507 of the desired key option. Selection may involve changing the display of that particular key, for example. Input may involve entering the desired key option at the cursor location, for example. In some cases, selection and/or input may involve performing a command or function, particularly where the selected/input key option is a navigation key, editing key, modifier key, miscellaneous keyboard key, or some combination thereof.

After the desired key option has been selected/input in response to the swipe gesture made on the virtual keyboard key, the method continues with a default action 508, such as exiting the keyboard key swipe mode or doing nothing until further user contact/input is received. For example, after a key option for a particular key has been selected (e.g., using a swipe gesture in the direction of the desired key option), a subsequent tap on that particular key may then input the key option. Likewise, the received contact can be reviewed for some other UI request, as done at 503. The method may continue in the touch monitoring mode indefinitely or as otherwise desired, so that any contact provided by the user can be evaluated for use in the keyboard key swipe mode if appropriate. As previously indicated, the keyboard key swipe mode may be configured to be exited by, for example, the user releasing the ending contact point or pressing a release mode UI feature such as the home button or a touch screen feature. In some instances, the keyboard key swipe mode may be tied to the virtual keyboard such that it will only be available when a virtual keyboard is being displayed. In this instance, power and/or memory may be conserved since the keyboard key swipe mode will only run or otherwise be available when the virtual keyboard is displayed.

Numerous variations and embodiments will be apparent in light of this disclosure. One example embodiment of the present invention provides a device including a display for displaying content to a user, and a touch sensitive surface for allowing user input. The device also includes a user interface including a virtual keyboard configured with a plurality of keys, each key having one or more key options, wherein a swipe gesture started on a particular key of the virtual keyboard causes a corresponding key option selection determined by the direction of the swipe gesture, and the other keys are not affected by the swipe gesture. In some cases, the display is a touch screen display that includes the touch sensitive surface. In some cases, the key options include letters, numbers, symbols, glyphs, navigation keys, editing keys, modifier keys, special characters, miscellaneous keyboard keys, and/or a combination thereof. In some cases, an upward swipe gesture performed on a letter key causes an uppercase selection of said letter key and a downward swipe gesture performed on the letter key causes a lowercase selection of said letter key. In some cases, a rightward swipe gesture performed on an alphanumeric key causes a first character selection and a leftward swipe gesture performed on the alphanumeric key causes a second character selection. In some cases, each virtual keyboard key has four assignable key options selectable through one of an upward, downward, leftward, and rightward swipe started from a particular key. In some cases, the key options for each key of the virtual keyboard are displayed within the bounds of each key. In some cases, holding the starting contact point of the swipe gesture for a preset duration of time causes a pop-up display of the key options for the particular key. In some cases, the user interface is configured to simultaneously transition all keys of the virtual keyboard in response to a change-all-keys user input, such that each key of the keyboard transitions to a corresponding one of the one or more key options associated with that key as determined by a direction of the change-all-keys user input. In some cases, the key options are user-configurable. In some cases, the key option selection causes the key option to be input to the device. In some cases, a subsequent tap on the particular key causes the corresponding key option selection to be input to the device.

Another example embodiment of the present invention provides a mobile computing device including a display having a touch screen interface and for displaying content to a user, and a user interface including a virtual keyboard configured with a plurality of keys, each key having one or more key options, and a keyboard key swipe mode that is configured to be activated in response to user contact via the touch sensitive interface, wherein the user contact includes a swipe gesture started on a particular key of the virtual keyboard and causes a corresponding key option input determined by the direction of the swipe gesture. In some cases, the key options for the particular key pop-up after the starting contact point is held for a preset duration. In some cases, key options are assigned to one of an upward, rightward, downward, and leftward swipe gesture per alphanumeric key.

Another example embodiment of the present invention provides a computer program product including a plurality of instructions non-transiently encoded thereon to facilitate operation of an electronic device according to a process. The computer program product may include one or more computer readable mediums such as, for example, a hard drive, compact disk, memory stick, server, cache memory, register memory, random access memory, read only memory, flash memory, or any suitable non-transitory memory that is encoded with instructions that can be executed by one or more processors, or a plurality or combination of such memories. In this example embodiment, the process is configured to activate a keyboard key swipe mode in a device capable of displaying content in response to user input via a touch sensitive interface of the device (wherein the user input including a swipe gesture initiated on a particular key of a virtual keyboard of the device to indicate a desired key option determined by the direction of the gesture, and select the desired key option (wherein the other keys are not affected by the selection). In some cases, an upward swipe gesture performed on a letter key causes an uppercase selection of said letter key and a downward swipe gesture performed on the letter key causes a lowercase selection of said letter key. In some cases, the keyboard key swipe mode allows key options to be assigned to one of an upward, rightward, downward, and leftward swipe gesture per key. In some cases, the process is configured to display a pop-up of available key options for a particular key in response to user input via the touch sensitive interface of the device capable of displaying content (wherein the user input includes holding the starting contact point over the particular key for a preset duration). In some cases, selection of the desired key option causes the key option to be input to the device.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A device, comprising:
a display for displaying content to a user;
a touch sensitive surface for allowing user input; and
a user interface including a virtual keyboard configured with a plurality of keys, each key having one or more key options, wherein a swipe gesture started on a particular key of the virtual keyboard causes a corresponding key option selection determined by the direction of the swipe gesture, and the other keys are not affected by the swipe gesture.

2. The device of claim 1 wherein the display is a touch screen display that includes the touch sensitive surface.

3. The device of claim 1 wherein the key options include letters, numbers, symbols, glyphs, navigation keys, editing keys, modifier keys, special characters, miscellaneous keyboard keys, and/or a combination thereof.

4. The device of claim 1 wherein an upward swipe gesture performed on a letter key causes an uppercase selection of said letter key and a downward swipe gesture performed on the letter key causes a lowercase selection of said letter key.

5. The device of claim 1 wherein a rightward swipe gesture performed on an alphanumeric key causes a first character selection and a leftward swipe gesture performed on the alphanumeric key causes a second character selection.

6. The device of claim 1 wherein each virtual keyboard key has four assignable key options selectable through one of an upward, downward, leftward, and rightward swipe started from a particular key.

7. The device of claim 1 wherein the key options for each key of the virtual keyboard are displayed within the bounds of each key.

8. The device of claim 1 wherein holding the starting contact point of the swipe gesture for a preset duration of time causes a pop-up display of the key options for the particular key.

9. The device of claim 1 wherein the user interface is further configured to simultaneously transition all keys of the virtual keyboard in response to a change-all-keys user input, such that each key of the keyboard transitions to a corresponding one of the one or more key options associated with that key as determined by a direction of the change-all-keys user input.

10. The device of claim 1 wherein the key options are user-configurable.

11. The device of claim 1 wherein the key option selection causes the key option to be input to the device.

12. The device of claim 1 wherein a subsequent tap on the particular key causes the corresponding key option selection to be input to the device.

13. A mobile computing device, comprising:
a display having a touch screen interface and for displaying content to a user; and
a user interface including a virtual keyboard configured with a plurality of keys, each key having one or more key options, and a keyboard key swipe mode that is configured to be activated in response to user contact via the touch sensitive interface, wherein the user contact includes a swipe gesture started on a particular key of the virtual keyboard and causes a corresponding key option input determined by the direction of the swipe gesture.

14. The device of claim 13 wherein the key options for the particular key pop-up after the starting contact point is held for a preset duration.

15. The device of claim 13 wherein key options are assigned to one of an upward, rightward, downward, and leftward swipe gesture per alphanumeric key.

16. A computer program product comprising a plurality of instructions non-transiently encoded thereon to facilitate operation of an electronic device according to the following process, the process comprising:
in response to user input via a touch sensitive interface of a device capable of displaying content, activate a keyboard key swipe mode in the device, wherein the user input includes a swipe gesture initiated on a particular key of a virtual keyboard of the device to indicate a desired key option determined by the direction of the gesture; and
select the desired key option, wherein the other keys are not affected by the selection.

17. The computer program product of claim 16 wherein an upward swipe gesture performed on a letter key causes an uppercase selection of said letter key and a downward swipe gesture performed on the letter key causes a lowercase selection of said letter key.

18. The computer program product of claim 16 wherein the keyboard key swipe mode allows key options to be assigned to one of an upward, rightward, downward, and leftward swipe gesture per key.

19. The computer program product of claim 16, the process further comprising:
in response to user input via the touch sensitive interface of the device capable of displaying content, display a pop-up of available key options for a particular key, wherein the user input includes holding the starting contact point over the particular key for a preset duration.

20. The computer program product of claim 16 wherein selection of the desired key option causes the key option to be input to the device.
